(19) United States
(12) Patent Application Publication
(10) Pub. No.: US 2013/0307661 A1
(43) Pub. Date: Nov. 21, 2013

(54) PROTECTIVE DEVICE AND THERMAL PROTECTION ELEMENT, IN PARTICULAR FOR THE CONTROL ELECTRONICS OF A MOTOR VEHICLE COMPONENT

(71) Applicant: BROSE FAHRZEUGTEILE GMBH & CO. KOMMANDITGESELLSCHAFT, WUERZBURG, WUERZBURG (DE)

(72) Inventor: GEORG WINHEIM, GEMUENDEN (DE)

(73) Assignee: BROSE FAHRZEUGTEILE GMBH & CO. KOMMANDITGESELLSCHAFT, WUERZBURG, WUERZBURG (DE)

(21) Appl. No.: 13/947,343

(22) Filed: Jul. 22, 2013

Related U.S. Application Data
(63) Continuation of application No. PCT/EP2012/000258, filed on Jan. 20, 2012.

(30) Foreign Application Priority Data
Jan. 21, 2011 (DE) 202011011820.2

(51) Int. Cl. H01H 37/76

(52) U.S. Cl. CPC H01H 37/761
USPC 337/401

(57) ABSTRACT

A protective device for control electronics of a motor vehicle component, such as a radiator fan drive, has a thermal protection element between the control electronics and a connecting lead frame. The thermal protection element trips when the temperature in the control electronics rises above a threshold temperature value. The thermal protection element has two conductor segments with conductor ends facing each other and forming an interruption point and one connecting end each. The interruption point is bridged by a fluxing agent, the fusion temperature of which is matched to the threshold temperature value. One of the connecting ends of the thermal protection element is connected to a contact of the connecting lead frame and the other connecting end is connected to a contact of the control electronics.

### CROSS-REFERENCE TO RELATED APPLICATION

This application is a continuation, under 35 U.S.C. §120, of copending international patent application No. PCT/EP2012/000258, filed Jan. 20, 2012, which designated the United States; this application also claims the priority, under 35 U.S.C. §119, of German application No. 20 2011 011 820.2, filed Jan. 21, 2011; the prior applications are herewith incorporated by reference in their entirety.

### BACKGROUND OF THE INVENTION

### Field of the Invention

The invention relates to a protective device with a thermal protection element that is tripped when there is a rise in temperature above a threshold temperature value. The preferred intended use of the protective device is the control electronics of a motor vehicle component, in which the thermal protection element is disposed in the region between the control electronics and a connecting lead frame. A motor vehicle component, in the context of this description, is understood to mean, in a particular example, a radiator fan drive with an electronically controlled DC motor for cooling the cooling water of a motor vehicle.

German published patent application DE 10 2007 011 548 A1 describes an adjustment system of a motor vehicle, such as for example a window lifter, a seat adjustment mechanism or a door or sliding roof drive, which is operated by an electric motor and has drive electronics for controlling the electric motor. In addition to software-based thermal protection, a thermal fuse element in the form of a spring element as overload protection is held in a segment of a strip conductor between two solder points that leads to the electric motor. If there is an overload current flowing for a certain time, the solder at one of the solder points is melted, so that, as a result of the biasing of the spring element, the strip conductor is spontaneously interrupted. This thermal fuse may be configured as a biased spring element similar to a spiral spring, as a leaf spring or as a cross-sectional constriction in the manner of an expanding-wire fuse.

German patent DE 10 2007 025 345 B4 describes using in a DC fan motor of a motor vehicle a thermal protection element in the form of a TCO element (thermal cut-off element), a fusible link or a bimetal switch in connection with a plastic-encapsulated lead frame, which is disposed between a DC voltage supply connection and control electronics and is thermally coupled to the latter. If the temperature of the control electronics exceeds a predetermined threshold value, the thermal protection element trips and interrupts the electrical connection between the DC voltage supply connection and the control electronics.

A TCO element (thermal cut-off element) is understood here as meaning a spring-biased pair of contacts connected by way of solder, the contacts of which open and interrupt the circuit when the solder melts as a result of the spring restoring force. A fusible link is usually realized by a fusible element connecting two electrical contacts. The fusible element heats up as a result of the current flowing through it and melts if the rated current is significantly exceeded.

The prior art thermal protection elements are configured, on the one hand, for electronically controlled electric motors and, on the other hand, for a rather low current carrying capacity and a relatively small operating temperature range of up to about 80° C.

### SUMMARY OF THE INVENTION

It is accordingly an object of the invention to provide a protective device which overcome the above-mentioned disadvantages of the heretofore-known devices and methods of this general type and which provides for a particularly reliable protective device that is configured, in particular, for control electronics of a motor vehicle component and is particularly suitable for performing a protective function in that context.

With the foregoing and other objects in view there is provided, in accordance with the invention, a protective device, comprising:

a thermal protection element configured to trip upon a temperature rise above a threshold temperature value;

said thermal protection element having two conductor segments with conductor ends, facing one another at an interruption point, and each of said conductor segments having a connecting end;

a fluxing agent disposed to bridge said interruption point and having a melting temperature adapted to the threshold temperature value.

The protective device is particularly configured for the thermal protection of a control electronics of a motor vehicle component, in particular for a drive of a radiator fan.

With the above and other objects in view there is also provided, in accordance with the invention, a thermal protection element, comprising:

a first conductor segment formed with a conductor end, facing an interruption point, and a connecting end;

a second conductor segment formed with a conductor end, facing the interruption point, and a connecting end; and

a fluxing agent, bridging the interruption point and connecting said conductor end of said first conductor segment and said conductor end of said second conductor segment.

In other words, the thermal protection element has two conductor segments, bridged in the region of an interruption point by a fluxing agent. The conductor segments have conductor ends facing one another to form the interruption point and in each case have a connecting end, these connecting ends forming the two contact ends of the thermal protection element.

The fluxing agent enclosing the two conductor ends of the conductor segments reaches around at least one of the conductor ends in the longitudinal direction of the conductor over a conductor segment that is set in a specific relation to the width of the interruption point and is shorter than the width of the interruption point. Particularly suitable is an overlapping region or enclosing portion of the respective conductor segment that is 10% of the overall length of the thermal protection element extending over the two conductor segments, including the interruption point. Proven to be particularly expedient is an overall length of the thermal protection element of 30 mm with a width of the interruption point of 5 mm, and so the respective enclosing portion preferably on both sides of the interruption point at the conductor ends is 3 mm. With approximately circular cross sections of the conductor segments and of the fusing point, these dimensions are suitably combined with a diameter of the fluxing agent that is 2 to 2.5 times, preferably 2.2 times, the diameter of the conductor segment.

In accordance with a particularly preferred feature of the invention, one of the connecting or contact ends of the thermal protection element is connected to a contact of a connecting lead frame of a wiring or cabling harness, for example leading from the on-board battery of the motor vehicle to the electronics and there to a circuit board (PCB) assigned thereto, while the other connecting end is then connected to a contact of the control electronics or of the circuit board. In the case of this embodiment or this intended use, the connecting lead frame is expediently encapsulated in a suitable material to produce an insulating wiring or cabling connection housing.

The melting temperature of the fluxing agent is adapted to a threshold temperature value, which is dependent on the choice of material and the dimensions, and possibly also the geometry, of the fluxing agent. The melting temperature is preferably between 170° C. and 260° C. The threshold temperature value is for its part determined by an inadmissibly high rise in temperature in the respective electronics. If the temperature of the or in the electronics rises to values above the threshold temperature value, and consequently above the melting temperature of the fluxing agent, the latter melts and interrupts the current/voltage supply to the electronics.

The fluxing agent is suitably a solder of a metal alloy adapted to the threshold temperature value, in particular with constituents of lead, tin, silver and/or copper. The structural or cross-sectional form of the thermal protection element may be round or polygonal. If the fluxing agent bridge of the thermal protection element is incorporated in a housing, the molten material—that is to say the melted fluxing agent or solder—can be absorbed by a filling material. As an additional function, this may also serve for quenching a possible arc.

In principle, crimp-like pinched connections of the connecting ends of the thermal protection element to the contacts of the conductor and the electronics are indeed conceivable. However, the contact of the connecting lead frame is preferably an insulation displacement contact for clamping-contacting of the assigned connecting end of the thermal protection element. The contact of the control electronics is also an insulation displacement contact mounted on the circuit board, for example by the SMD technique, for the clamping-contacting of the assigned connecting end of the thermal protection element.

In order to realize a current carrying capacity that is as high as possible, as also required for example in the preferred application for a radiator fan drive, the insulation displacement contacts are formed as pairs of contacts. For this purpose, two insulation displacement contacts are respectively disposed at a distance from one another and are connected in an electrically conducting manner to one another, the insulation displacement slits of which being in line with one another.

The advantages achieved with the invention are, in particular, that virtually any desired external geometry (round, angular, straight or curved) can be realized by means of the thermal protection element, preferably bridged with solder, with at the same time a simple construction. Furthermore, the thermal protection element according to the invention does not contain any movable parts, so that in particular there is also no mechanical stress, for example as a result of a biasing force. The interruption of the current flow consequently specifically does not take place by movable mechanical components, and the galvanic growing together of the opened fluxing agent bridge leads to renewed melting of the fluxing agent. Consequently, there is sustained safety even after the initial tripping.

Furthermore, the tripping temperature of the thermal protection element can be predetermined by the choice of fluxing agent. Furthermore, the force effect on the circuit board (PCB) of the electronics is reduced during assembly of the wiring or cabling harness. In the case of variants of the embodiment without thermal protection, the pressing in of an enameled copper wire instead of the thermal protection element into the insulation displacement contacts is also possible.

Other features which are considered as characteristic for the invention are set forth in the appended claims.

Although the invention is illustrated and described herein as embodied in protective device, in particular for the control electronics of a motor vehicle component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of a detail of a thermal protection element fixed in insulation displacement contacts;

FIG. 2 is an end view of an insulation displacement contact, illustrating the contacting of the thermal protection element;

FIG. 3 is a side view illustrating the thermal protection element fixed in pairs of insulation displacement contacts, with an encapsulated connecting lead frame (wiring or cabling harness lead frame) disposed underneath a circuit board and having pairs of insulation displacement contacts led onto the upper side of the PCB;

FIG. 4 is a plan view of the insulation displacement contacting of the thermal protection element between the insulation displacement contact on the circuit board side and the insulation displacement contact on the cabling harness or wiring side;

FIG. 5 is an illustration similar to that of FIG. 4 with an encapsulated connecting lead frame;

FIG. 6A is a cross-section through the thermal protection element;

FIG. 6B is a longitudinal section through the thermal protection element taken along the line VIB-VIB in FIG. 6A;

FIG. 7 is a perspective representation of a radiator fan drive for a motor vehicle, with integrated converter electronics, looking onto a connecting side of the motor; and

FIG. 8 is a plan view onto the motor according to FIG. 7, with the electronics compartment cover (i.e., housing cover) removed.

### DETAILED DESCRIPTION OF THE INVENTION

Reference will now be had to the figures of the drawing in which components that correspond to one another are provided with the same reference signs throughout the figures.

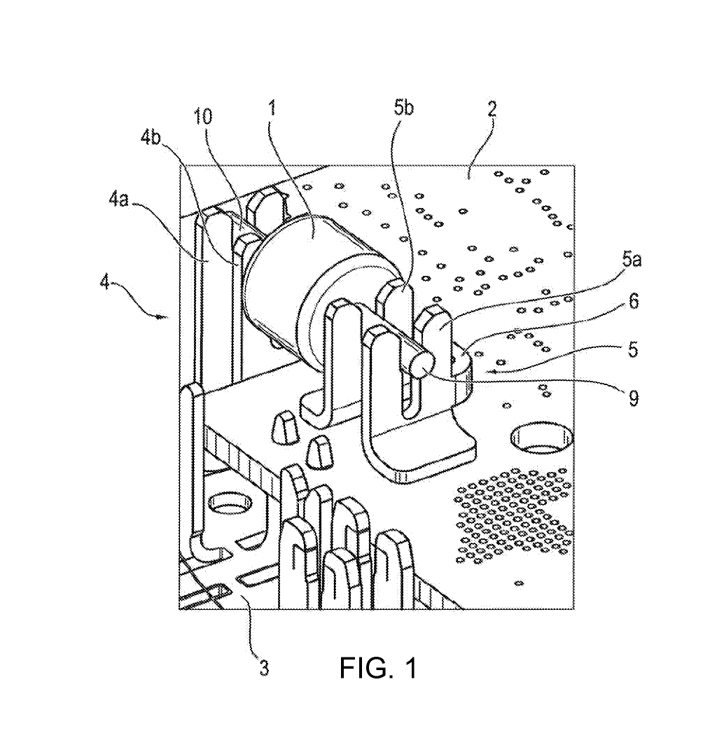

FIGS. 1 to 5 show a thermal protection element 1 of the control electronics of a motor vehicle component, represented in the present case by a circuit board 2. In a way that is not represented any more specifically, this is in particular a radiator fan drive with an electronically controlled DC motor. Led onto or into the electronics is a lead frame 3 of a wiring or cabling harness (cabling harness lead frame), which can only be seen in the form of a detail and has various, rising-up connecting contacts. One of these connecting contacts of the connecting lead frame 3 is configured as a pair of insulation displacement contacts 4 with two insulation displacement contacts 4a and 4b spaced apart from one another and in line with one another. These may be the terminal 30 (negative pole) or 31 (continuous positive).

A further pair of insulation displacement contacts 5 with likewise two insulation displacement contacts 5a and 5b spaced apart from one another are mounted on the circuit board 2, for example by the SMD technique (surface mounted device), and if need be electrically contacted there with a strip conductor.

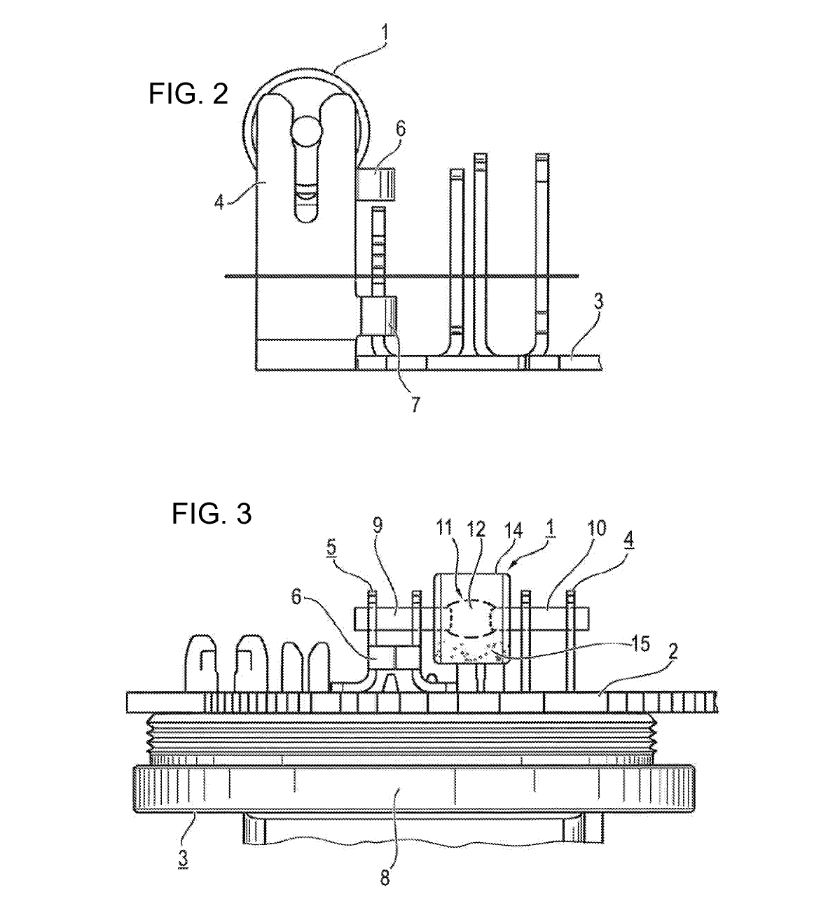

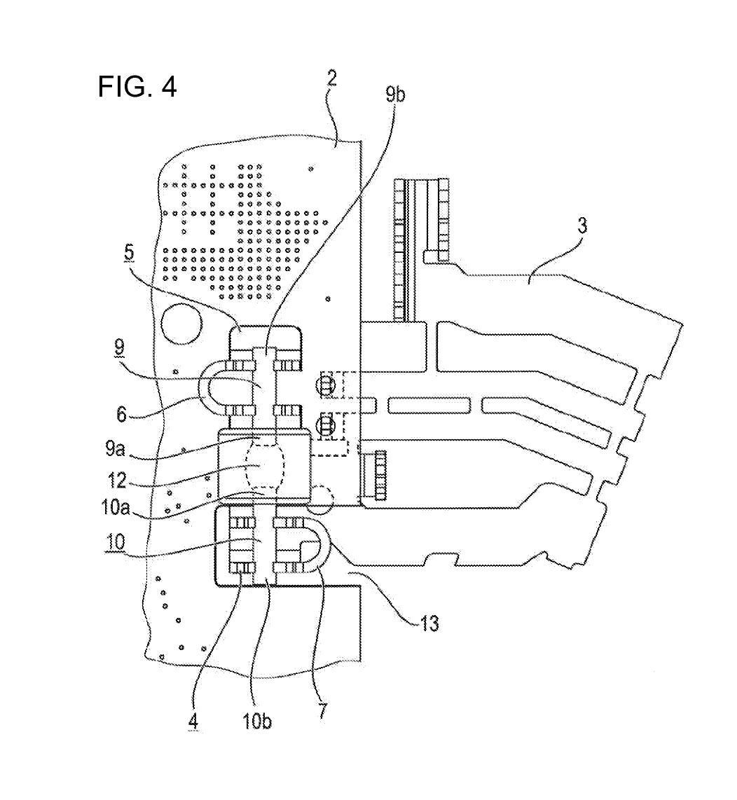

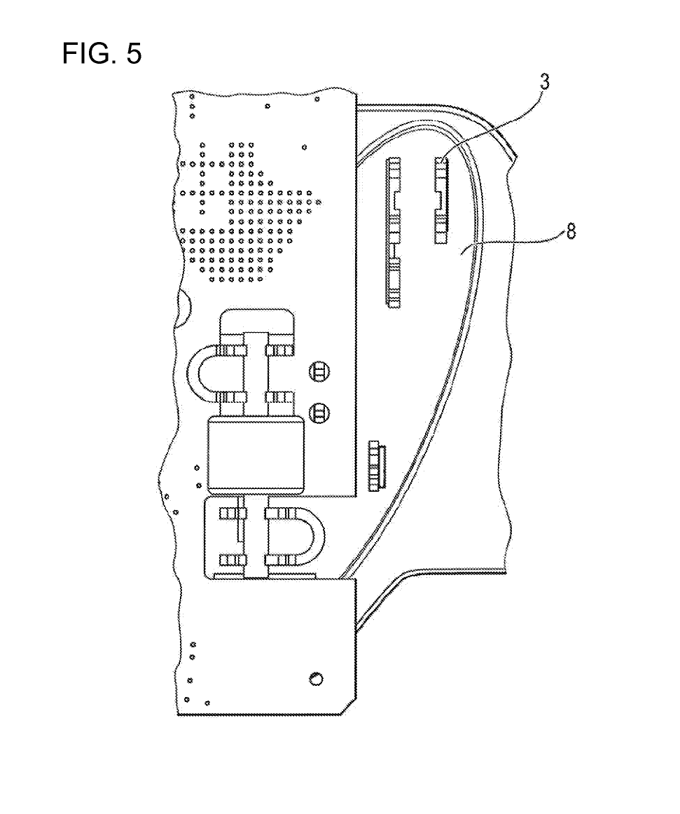

As can be seen from the pair of insulation displacement contacts 5 in FIG. 1, the two insulation displacement contacts 5a and 5b are connected to one another in a material-bonding and electrically conducting manner by way of a contact bridge 6. By analogy, the insulation displacement contacts 4a and 4b of the pair of insulation displacement contacts 4 on the cable side are also connected to one another in a material-bonding and electrically conducting manner by means of a contact bridge 7, as can be seen comparatively clearly from FIGS. 2 and 4. The contact or connection bridges 6, 7 of the pairs of insulation displacement contacts 5 and 4, respectively, are produced from an appropriate, suitable contact sheet by the punching and bending process.

As can be seen from FIGS. 3 and 5, the connecting or cabling harness lead frame is encapsulated in a suitable material for the production of an insulating wiring or cabling connection housing 8.

The thermal protection element 1 consists of a first conductor segment 9 and a second conductor segment 10, which are spaced apart from one another to form an interruption point 11. The interruption point 11 is bridged by a fluxing agent 12 in the form of a solder, for example a lead solder. For this purpose, the conductor ends 9a and 10a of the conductor segments 9 and 10, respectively, are spaced apart opposite one another and are connected to one another in an electrically conducting manner by way of the solder 12.

The connecting ends 9b and 10b lying opposite the conductor ends 9a, 10a of the conductor segments 9, 10 are fixed in the insulation displacement contacts 5 and 4, respectively, and are consequently connected in an electrically conducting manner on the one hand to the connecting lead frame 3 and on the other hand to a strip conductor of the circuit board 2 contacted with the pair of insulation displacement contacts 5. As can be seen comparatively clearly from FIGS. 1, 4 and 5, the thermal protection element 1 is substantially mounted on the circuit board 2. For this purpose, the circuit board 2 has a cutout 13, into which the pair of insulation displacement contacts 4 of the connecting lead frame 3 are led.

The thermal protection element 1 is consequently exposed to a development of heat occurring in the electronics, and consequently in the region of the circuit board 2. Since the circuit board 2, and consequently the electronics, is/are usually in a drive housing, for example of a radiator fan drive, the development of heat of the electronics under some circumstances leads to a rise in temperature, for example as a result of ingressing moisture and resultant undesired current flows. If the temperature rises above a certain threshold temperature value, the solder 12 melts, whereby the electrically conducting connection between the conductor segments 9 and 10 is interrupted in the region of the interruption point 11. The melting temperature of the solder 12 is in this case set to the threshold temperature value. This takes place substantially by the geometry and the dimensions, i.e. the size, of the solder 12 and the material thereof, which for its part is composed on the basis of an appropriately chosen metal alloy of components such as lead, tin, silver and/or copper. The melting temperature is typically 170° to 260° C., for example approximately 180° C.

The thermal protection element 1 also has a housing 14, which in the exemplary embodiment is cylindrical. The housing 14 encloses the interruption point 11 with the solder 12 and at least partially the conductor segments 9 and 10 in the region of their conductor ends 9a and 10a, respectively. Inside the housing 14 there is a filling material 15, which in the case of the solder 12 melting absorbs it. The filling material 15 may also be intended and designed for quenching an arc. The housing 14 also ensures that the melting solder remains encapsulated within the thermal protection element 1.

The conductor segments 9, 10 are formed for example from copper wires, the wire cross sections of which are adapted to the required current carrying capacity of the thermal protection element 1. The cross-sectional area of the conductor segments 9, 10 is of almost any form desired, and may be round or polygonal. The conductor segments 9, 10 may also be straight—as shown in the exemplary embodiment—or else curved.

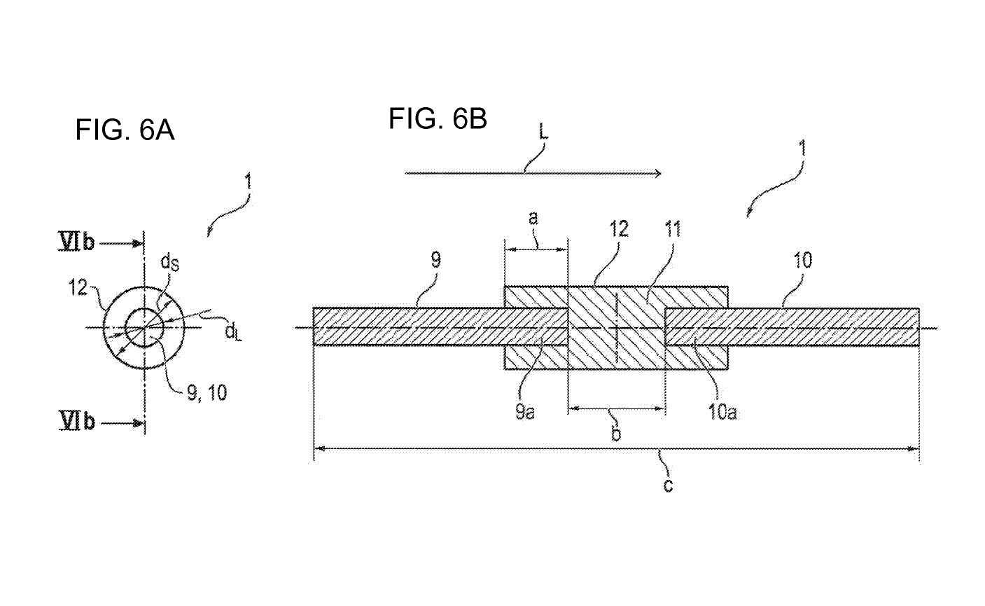

FIGS. 6a and 6b show the thermal protection element 1 in cross section and in longitudinal section, respectively. As can be seen, the fluxing agent 12 encloses the conductor end 9a and the conductor end 10a in the longitudinal direction L of the conductor over a conductor segment a, which is shorter than the width b of the interruption point 11. The conductor segment a is ten percent (10%) of the total length c extending over the two conductor segments 9, 10, including the interruption point 11, where preferably c=30 mm, b=5 mm and consequently a=3 mm. The diameter dS of the fluxing agent 12, preferably consisting of tin (Sn) or containing tin, is preferably 4 mm with a diameter dL of the, or each, conductor segment 9, 10, preferably consisting of copper (Cu), of 1.8 mm.

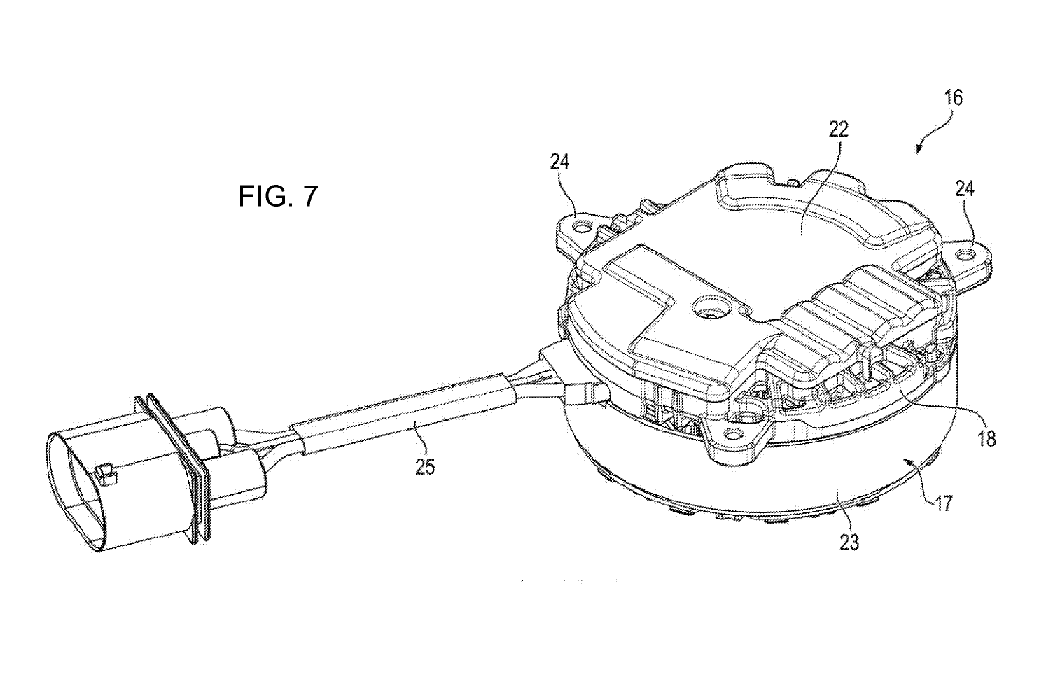

FIG. 7 shows the electric motor 16 of a fan for the radiator of a motor vehicle. The motor 16 is substantially formed by a stator 17, which is wound with a three-phase rotating-field winding in the form of coils. The motor 16 comprises furthermore a permanently excited rotor (not visible), which is mounted rotatably about a motor axis inside the stator 17. The motor 16 also comprises an approximately disk-shaped motor support 18, incorporated in which is an electronics compartment 20, fitted in which are converter electronics 21. For the sealed closing of the electronics compartment 20, the motor 16 comprises an electronics compartment cover 22, also referred to hereinafter as a housing cover.

The stator 17 consists of a stack of sheets, which is encapsulated in a plastic casing 23. The motor support 18 is formed in particular by a one-piece die casting of aluminum. The electronics compartment cover 22 is preferably an injection molding of plastic. The fastening of the motor 16, and consequently of the entire fan, to the vehicle takes place by way of the motor support 18, which for this purpose is provided with three screw lugs 24, protruding from its outer periphery. The motor 16 is a brushless self-cooled internal-rotor motor.

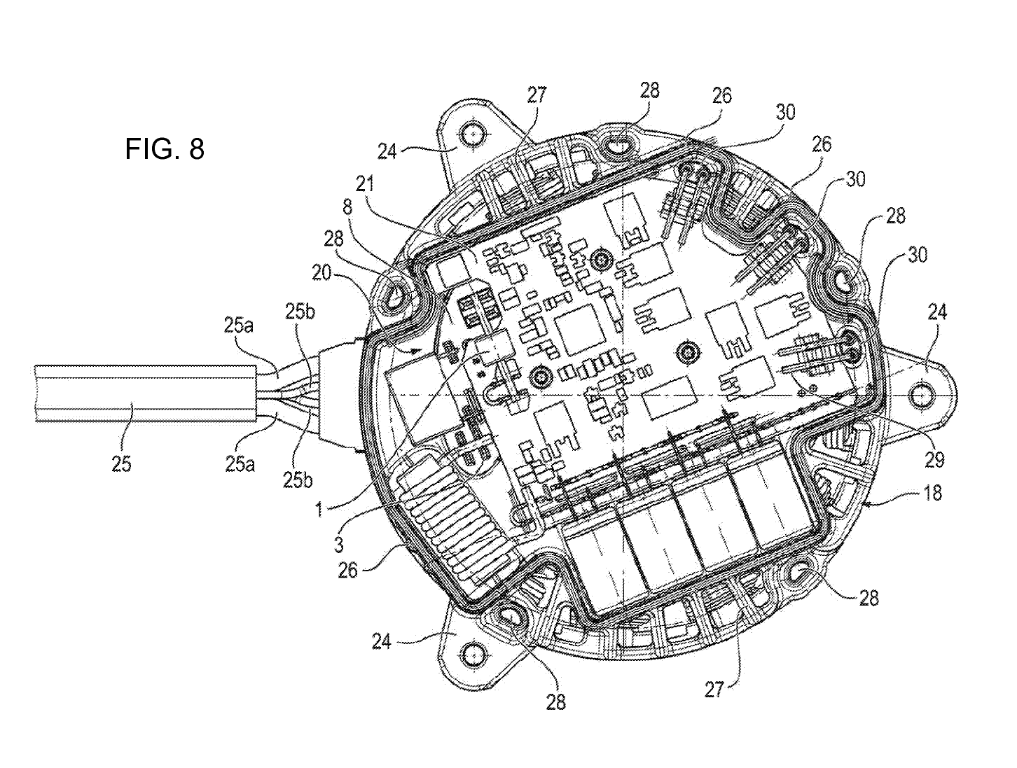

FIG. 8 shows the motor 16 with the electronics compartment cover 22 removed, looking into the electronics compartment 20 with the converter electronics 21 disposed therein. Led onto it and contacted with it are supply lines (positive and negative or ground pole) 25a and sensor or data lines 25b of a connecting cable 25. The electronics compartment 20 is enclosed by a peripheral, closed sealing or joining rim 26. Outside the electronics compartment 20, the motor support 18 has substantially radially running clamping ribs 27 for the electronics compartment cover 22. At a number of positions distributed around the periphery of the motor support 18 there are fixing or caulking openings 28. Pairs of winding ends 29 of a rotating-field winding of the stator 18 of the motor 16 are led into the electronics compartment 20 in a sealing manner by way of sealing elements 30 in corresponding through-openings of the motor support 18.

In particular from FIG. 8 in conjunction with FIGS. 3 and 5 there can be seen comparatively clearly the encapsulated connecting or cabling harness lead frame 3, on which in particular the supply lines 25a of the connecting cable 25 are contacted or plug-contacted, with the insulating wiring or cabling connection housing 8.

Although the thermal protection element 1 preferably serves as a protective device for the control electronics of a motor vehicle component, the invention is not restricted to the exemplary embodiments described above. Rather, other variants of the invention may also be derived from it by a person skilled in the art without departing from the subject matter of the invention. For example, the thermal protection element 1 is suitable for fitting between in turn a lead frame and a brush card or between an inductor and a brush list of the electric motor or for fitting into a PCB or circuit board by means of selective soldering. In particular, furthermore, all of the individual features described in connection with the various exemplary embodiments can also be combined with one another in some other way without departing from the subject matter of the invention.

The following is a list of reference numerals and symbols used in the above description of the drawing figures:
1 thermal protection element
2 circuit board
3 connecting lead frame
4 pair of insulation displacement contacts on the lead frame side
5 pair of insulation displacement contacts on the circuit board side
6 contact bridge
7 contact bridge
8 connection housing
9 conductor segment
9a conductor end
9b connecting end
10 conductor segment
10a conductor end
10b connecting end
11 interruption point
12 fluxing agent/solder
13 clearance
14 housing
15 filling material
16 fan motor
17 stator
18 motor support
20 electronics compartment
21 converter electronics
22 electronics compartment cover
23 plastic casing
24 connecting cable
25 sealing rim
26 clamping rib
27 screw lug
28 connecting cable
25a supply line (positive/negative pole)
25b sensor/data line
26 joining rim
27 clamping rib
28 caulking nub
29 pair of winding ends
30 sealing element
a conductor segment
b width of 11
c total length of 1
dS diameter of 12
dL diameter of 9, 10
L longitudinal direction of conductor

1. A protective device, comprising:
a thermal protection element configured to trip upon a temperature rise above a threshold temperature value;
said thermal protection element having two conductor segments with conductor ends, facing one another at an interruption point, and each of said conductor segments having a connecting end;
a fluxing agent disposed to bridge said interruption point and having a melting temperature adapted to the threshold temperature value.

2. The protective device according to claim 1, wherein said thermal protection element and the threshold temperature value are adapted to protect a control electronics of a motor vehicle component.

3. The protective device according to claim 2, wherein:
the protective device is configured for the control electronics of a motor vehicle component;
said thermal protection element is disposed in a region between the control electronics and a connecting lead frame; and
one of said connecting ends of said thermal protection element is connected to a contact of the connecting lead frame and the other said connecting end is connected to a contact of the control electronics.

4. The protective device according to claim 3, wherein the motor vehicle component is a radiator fan drive.

5. The protective device according to claim 3, wherein the connecting lead frame is encapsulated to form an insulating wiring or cabling connection housing.

6. The protective device according to claim 3, wherein the contact of the connecting lead frame is an insulation displacement contact for engaging in a clamping contact with the respective said connecting end of said thermal protection element.

7. The protective device according to claim 6, wherein the contact of the control electronics is an insulation displacement contact mounted on a circuit board for engaging in clamping contact with the respective said connecting end of said thermal protection element.

8. The protective device according to claim 7, wherein said insulation displacement contact is a pair of mutually spaced-apart contacts of insulation displacement contacts connected to one another in an electrically conducting manner.

9. The protective device according to claim 1, wherein said fluxing agent is a solder of a metal alloy adapted to the threshold temperature value.

10. A thermal protection element, comprising:
a first conductor segment formed with a conductor end, facing an interruption point, and a connecting end;
a second conductor segment formed with a conductor end, facing the interruption point, and a connecting end; and
a fluxing agent, bridging the interruption point and connecting said conductor end of said first conductor segment and said conductor end of said second conductor segment.

11. The thermal protection element according to claim 10, wherein said fluxing agent is solder and the thermal protection element is configured for contacting a wiring connection with a circuit board connection of drive electronics.

12. The thermal protection element according to claim 11, wherein the drive electronics is a radiator fan drive of a motor vehicle.

13. The thermal protection element according to claim 11, wherein said conductor end of said first conductor segment is disposed for contacting on a circuit board side, and said conductor end of said second conductor segment is disposed for contacting on a wiring side.

14. The thermal protection element according to claim 10, wherein at least one or both of said first and second conductor segments is configured for producing an insulation displacement contact.

15. The thermal protection element according to claim 10, which comprises a housing encasing said interruption point and said conductor ends of said first and second conductor segments facing said interruption point.

16. The thermal protection element according to claim 15, which comprises a filling material in said housing for absorbing melted fluxing material.

17. The thermal protection element according to claim 10, wherein said fluxing agent encloses at least one of said conductor end of said first conductor segment or said conductor end of said second conductor segment in a longitudinal direction of said conductor over a conductor segment, which is shorter than a width b of said interruption point.

18. The thermal protection element according to claim 17, wherein said conductor segment is ten percent of a total length c extending over said first and second conductor segments, including said interruption point.

19. The thermal protection element according to claim 18, wherein the total length c=30 mm and the width b=5 mm.

20. The thermal protection element according to claim 10, wherein a diameter of said fluxing agent is 2 to 2.5 times greater than a diameter of the respective said conductor segment.

21. The thermal protection element according to claim 20, wherein the diameter of said fluxing agent is 2.2 times the diameter of the respective said conductor segment.

22. An electromotive drive for a motor vehicle component, comprising a thermal protection element according to claim 10.
